(19) United States
(12) Patent Application Publication
(10) Pub. No.: US 2020/0080555 A1
(43) Pub. Date: Mar. 12, 2020

(54) Variable Displacement Pump

(71) Applicant: GM GLOBAL TECHNOLOGY OPERATIONS LLC, DETROIT, MI (US)

(72) Inventors: Andy Bennett, SR., Rochester Hills, MI (US); Sean M. McGowan, Northville, MI (US); Mark R. Claywell, Birmingham, MI (US)

(21) Appl. No.: 16/128,999

(22) Filed: Sep. 12, 2018

(51) Int. Cl. F04C 14/22; F04C 2/344

(52) U.S. Cl. CPC F04C 14/22; F15B 2211/20546; F04C 2/3442

(57) ABSTRACT

A variable displacement pump is provided which better distributes stress across the rotor structure thereby reducing the risk of the rotor cracking and/or failing. The variable displacement pump includes a housing, a vane control ring, a rotor, a plurality of vanes, a slider ring, a biasing means, and a regulator valve. The housing defines an inlet port and a discharge port. The rotor may be rotationally driven by a drive shaft and coaxially aligned with the drive shaft. The rotor may define a plurality of primary ribs and a plurality of corresponding secondary ribs with an aperture defined between each primary rib and secondary rib. Each primary rib defines a primary rib thickness and each secondary rib defines a secondary rib thickness which is less than the primary rib thickness.

### TECHNICAL FIELD

The present disclosure relates to variable displacement pumps and more particularly to vane type pumps.

### BACKGROUND

Mechanical systems, such as internal combustion engines and automatic transmissions, typically include a lubrication pump to provide lubricating oil, under pressure, to many of the moving components and/or subsystems of the mechanical systems. In most cases, the lubrication pump is driven by a mechanical linkage to the mechanical system and thus the operating speed, and output, of the pump varies with the operating speed of the mechanical system. While the lubrication requirements of the mechanical system also vary with the operating speed of the mechanical system, unfortunately the relationship between the variation in the output of the pump and the variation of the lubrication requirements of the mechanical system is generally nonlinear. The difference in these requirements is further exacerbated when temperature related variations in the viscosity and other characteristics of the lubricating oil and mechanical system are factored in.

To deal with these differences, prior art fixed displacement lubricating pumps were generally designed to operate safely and effectively at high, or maximum, oil temperatures, resulting in an oversupply of lubricating oil at most mechanical system operating conditions and a waste, or pressure relief, valve was provided to “waste” the surplus lubricating oil back into the pump inlet or oil sump to avoid over pressure conditions in the mechanical system. In some operating conditions such as low oil temperatures, the overproduction of pressurized lubricating oil can be 500% of the mechanical system's needs so, while such systems work reasonably well, they do result in a significant energy loss as energy is used to pressurize the unneeded lubricating oil which is then “wasted” through the relief valve.

More recently, variable displacement pumps have been employed as lubrication oil pumps. Such pumps generally include a pivoting ring, or other mechanism, which with the vanes and rotor can be operated to alter the volumetric displacement of the pump and thus its output at an operating speed. Typically, a feedback mechanism, in the form of a piston in a control chamber or a control chamber acting directly upon the pivoting ring, is supplied with pressurized lubricating oil from the output of the pump, either directly or via an oil gallery in the mechanical system, alters the displacement of the pump to operate the pump to avoid over pressure situations in the engine throughout the expected range of operating conditions of the mechanical system.

While such variable displacement pumps provide some improvements in energy efficiency over fixed displacement pumps, there can be issues wherein the rotor experiences excessive stress and may crack.

### SUMMARY

The present disclosure provides a variable displacement pump which better distributes stress across the rotor structure thereby reducing the risk of the rotor cracking and/or failing. The variable displacement pump includes a housing, a vane control ring, a rotor, a plurality of vanes, a slider ring, a biasing means, and a regulator valve. The housing defines an inlet port and a discharge port. The rotor may be driven by a drive shaft and coaxially aligned with the drive shaft. The rotor defines a plurality of primary ribs and a plurality of corresponding secondary ribs with an aperture and an optional curved surface defined between each primary rib and secondary rib. Each primary rib defines a primary rib thickness and each secondary rib defines a secondary rib thickness which is less than the primary rib thickness.

The plurality of vanes in the aforementioned variable displacement pump are slidably disposed in the rotor. Each vane in the plurality of vanes abuts the vane control ring at a proximate end of each vane while the distal end of each vane abuts the inner surface of the slider ring. The slider ring may be pivotally affixed to the housing via a pivot. The slider ring defines a displacement control region with a first portion of the housing. The slider ring cooperates with the vane control ring, the rotor, and the plurality of vanes to form a plurality of pumping chambers that are successively connected to the inlet and discharge ports. The biasing means acts on the slider ring and urges the slider ring in a first direction via a first force. A regulator valve is also provided so as to generate a varying input working fluid pressure via an input working fluid flow to the displacement control region via the inlet port which thereby generates a second force on the slider ring about the pivot means in a second direction. The second direction is opposite to the first direction. The second force may be configured to vary relative to the first force so as vary the volume of each pumping chamber while the rotor rotates via the drive shaft. As the varying input working fluid pressure is applied to the plurality of vanes and the rotor, a portion of the rotor is configured to elastically flex.

In the foregoing embodiment, at least one the secondary rib in the rotor is configured to flex when the varying input working fluid pressure is applied to the rotor and the plurality of vanes. It is also understood that the optional curved surface defined adjacent to the at least one secondary rib may also flex when the varying input working fluid pressure is applied to the rotor. The rotor of the foregoing embodiment may also include an outer rib region adjacent to each aperture, each secondary rib and each primary rib. The outer rib region of the rotor may be configured to rotate counter-clockwise relative to a distal end of the primary rib. It is understood that each curved surface in the rotor defines a rotor curved surface thickness which is less than the secondary rib thickness. The aforementioned curved surface(s) may be defined at the base of the secondary rib and/or optionally at a peripheral region of the secondary rib. Given that each secondary rib and the curved surface(s) adjacent to the corresponding secondary rib define thicknesses which are relatively less than the primary rib thickness, the secondary rib structures together with any corresponding curved surfaces in the rotor are configured to elastically flex when the varying input working fluid pressure is applied to the rotor.

In another embodiment of the present disclosure, a variable displacement pump is provided which includes a housing, a flexible rotor, a vane control ring, a plurality of vanes, a slider ring, a biasing means, and a regulator valve. The housing defines an inlet port and a discharge port wherein the inlet port is in fluid communication with the regulator valve. The flexible rotor may be rotationally driven by a drive shaft and coaxially aligned with the drive shaft. The rotor defines a plurality of primary ribs and a plurality of corresponding secondary ribs with an aperture defined between each secondary rib and each corresponding primary rib. Each primary rib defines a primary rib thickness and each secondary rib defines a secondary rib thickness which is less than the primary rib thickness. The rotor thickness proximate to the drive shaft opening may be at least as thick as the primary rib thickness.

In the aforementioned embodiment, the vane control ring may be disposed between the rotor and the housing wherein the vane control ring is configured to move within a perimeter of the rotor. The vane control ring may include an outer surface which abuts a proximate end for each vane in the plurality of vanes. The plurality of vanes may also be slidably disposed in the rotor in a plurality of corresponding vane slots. Moreover, the slider ring may be pivotally affixed to the housing via a pivot so as to define a displacement control region with a first portion of the housing. The slider ring may be configured to cooperate with the vane control ring, the rotor, and the plurality of vanes form a plurality of pumping chambers that are successively connected to the inlet and discharge ports when a varying input working fluid is supplied to the displacement control region. The biasing means may act on the slider ring so as to urge the slider ring in a first direction via a first (spring/biasing) force. However, the regulator valve is configured to and generates a varying input working fluid pressure via an input working fluid flow to the displacement control region which thereby generates a second force on the slider ring about the pivot means in a second direction. The second direction is opposite to the first direction. The second force (via the regulator valve) is intended to vary relative to the first force so as vary the volume of each pumping chamber while the flexible rotor rotates via the drive shaft.

In the aforementioned embodiment, at least one secondary rib in the rotor is configured to flex when the varying input working fluid pressure is applied to the rotor. Each secondary rib in the rotor, may but not necessarily be disposed adjacent to each vane slot. It is also understood that the biasing means may, but not necessarily, be a spring.

The present disclosure and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description, best mode, claims, and accompanying drawings in which:

FIG. 1 is a partial, plan view of a commonly used rotor and vanes which may be used in a traditional variable displacement pump.

FIG. 2 is a plan view of an example non-limiting variable displacement pump (with the cover removed) according to various embodiments of the present disclosure.

FIG. 3 is a sectional view taken along line 3-3 in FIG. 2.

FIG. 4 is an enlarged partial plan view of the flexible rotor in FIG. 2.

FIG. 5 is a plan view of the flexible rotor of FIG. 3.

FIG. 6 is a partial isometric view of the flexible rotor of FIG. 3.

Like reference numerals refer to like parts throughout the description of several views of the drawings.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, un-recited elements or method steps.

The phrase “consisting of” excludes any element, step, or ingredient not specified in the claim. The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this present disclosure pertains.

The following detailed description is merely exemplary in nature and is not intended to limit the present disclosure or the application and uses of the present disclosure. Furthermore, there is no intention to be bound by any theory presented in the preceding background or the following detailed description.

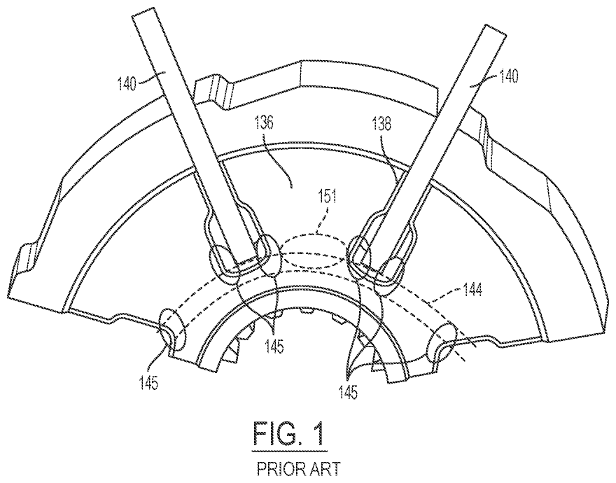

Referring now to FIG. 1, a traditional rotor, vane control ring and vanes are shown in a partial view. As the vanes 140 (disposed in vane slots 138) of the traditional variable pump are rotated, stress is applied to the base corners 145 (see FIG. 1) of the vane slots 138 in the rotor 136 due to flexion of the rotor 136 at the base corners 145 and due to the flexion of the vanes 140. The base corners 145 of the rotor 136 which experience high stress are shown in FIG. 1. It is understood that the thickness at each base corner 145 in the traditional rotor 136 have the same predetermined thickness.

As indicated, the base corners 145 may be subjected to stress imposed by the rotation/twisting/flexing of the vanes 140 disposed within the slots 138 so as to further cause undesirable flexion and cracking in the rotor 136 at the base corners 145. It is understood that the inlet oil pressure within the traditional variable pump may create a torsional force on a vane 140 every time the vane 140 is introduced to pressure changes between the inlet port to outlet port. The relatively significant inlet oil pressure (due to the inlet-outlet pressure differential) may causes one or more vanes 140 to bend within the slot(s) 138. As a result, the rotor 136 may experience excessive stress in one or more base corners 145 such that the rotor 136 may crack in the region 151 between (or proximate to) the base corners 145 or at base corners 145 thereby causing the pump to fail. Accordingly, there is a need to develop a more robust variable displacement pump which prevents such damage to the rotor.

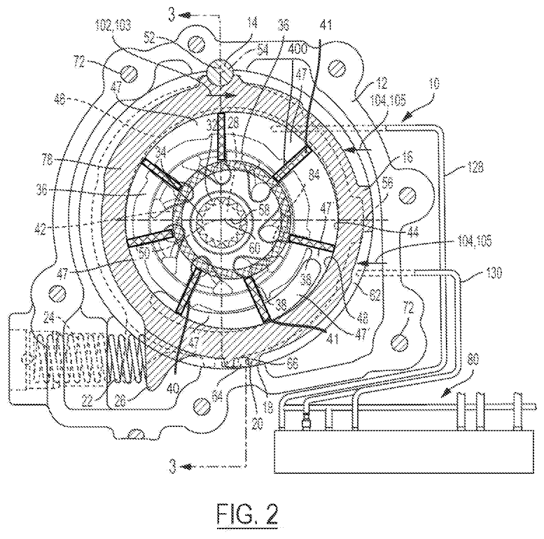

Referring now to FIGS. 2-4, a robust variable displacement pump 10 of the present disclosure is provided to overcome the foregoing stress/cracking issue at the rotor's base corners. An example, non-limiting robust pump 10 of the present disclosure includes a housing 12 in which is secured a pivot pin 14. A slider ring 16 is pivotally mounted on the pin 14 and slidably supported at 18 on a surface 20 formed in the housing 12. The slider ring 16 is urged to the position shown in solid lines in FIG. 2 by a compression spring 22 which is disposed in a cylindrical opening 24 formed in the housing 12 and abuts a lug 26 formed on the slider ring 16.

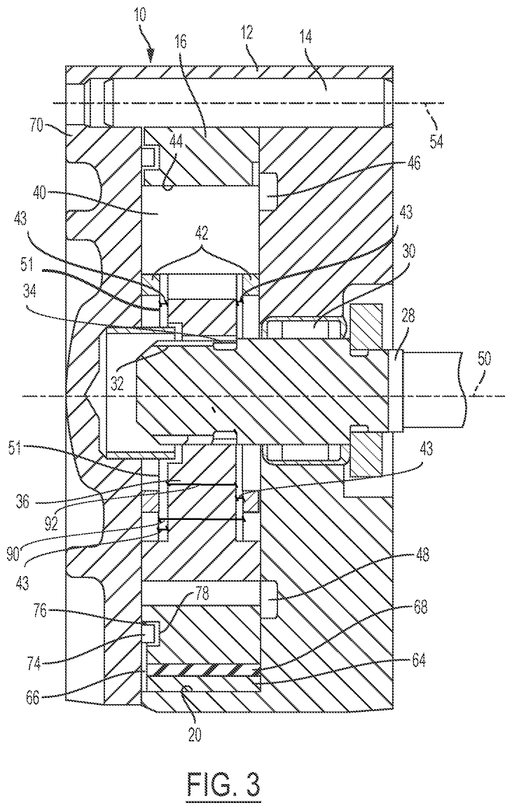

A pump drive shaft 28 of the present disclosure may be rotatably mounted in the housing 12 through a needle bearing 30, which drive shaft 28 has a splined end 32 (see FIG. 3) drivingly connected to a spline 34 formed on a flexible pump rotor 36. As shown in FIG. 2, the pump rotor 36 has a plurality of radial slots 38 formed therein in each of which slots 38 is slidably disposed a vane member 40. The vanes 40 are urged outwardly by a pair of vane control rings 42 and centrifugal force toward an inner surface 44 formed on the slider ring 16. As the flexible rotor 36 rotates via the drive shaft 28, a distal end 41 of each vane 40 abuts and slides against the inner surface 44 of the slider ring 16. The vane control ring 42 is continuous and may therefore maintain a fixed diameter.

Therefore, referring back to FIG. 2, with respect to a variable vane pump 10 of the present disclosure, a housing 12 is included which defines discharge port 46 and inlet port 48 for the pump 10. As shown in FIG. 2, a plurality of pumping chambers 47 are formed by the vanes 40, flexible rotor 36 and surface 44. The chambers 47 rotate with flexible rotor 36, and expand and contract during rotation. The inlet port 48 accepts fluid from a reservoir, not shown, as a vacuum is generated in the expanding chamber 47 and passes the fluid to the other chambers 47. The vanes 40 carry the fluid in the chambers 47 from the inlet port 48 to the discharge port 46. As can be seen in FIG. 2, if the pump rotor 36 may continuously rotate in a counter-clockwise direction, such that the chambers 47 are continually expanding, to take in fluid, in the area of inlet port 48 and are contracting, to discharge fluid, in the area of the discharge port 46.

The drive shaft 28 has a central axis 50 which is intersected by an axis 52 passing through the central axis 54 of the pivot pin 14. The axes 52 and 50 are intersected by an axis 56 which is disposed at right angles to the axis 52. In the slider ring's 16 position shown by solid lines in FIG. 2, the center of the inner surface 44 of slider ring is located at 58. However, when the slider ring 16 is moved to the minimum displacement, as shown by phantom lines (see FIG. 2) the center of inner surface 44 of slider ring is located at 60.

The position of slider ring 16 is established by control pressure in a chamber 62 which extends about the outer circumference of ring 16 from pivot pin 14 to a seal member 64 disposed in a curved surface 66 formed in the slider ring 16. Thus, the control fluid is confined to what is essentially a semi-cylindrical chamber 62. The spring (or biasing means) 22 acts in opposition to the control fluid in chamber 62 such that as the pressure in control chamber 62 increases, the pump ring 16 will be moved clockwise about pivot pin 14. The left face, as seen in FIG. 2, of the slider ring 16, flexible rotor 36 and chambers 47 are closed by a cover 70 which is secured to the housing 12 by a plurality of fasteners 72. Leakage from the chambers 47 radially outwardly past the cover 70 is prevented by a seal ring 74 (shown in FIGS. 2-3) disposed in a curved surface 76 (shown in FIGS. 2-3) formed in the slider ring 16 and urged toward the cover by a resilient backing ring 78. Any fluid leakage which occurs in a radially inward direction passes through the bearing 30.

The fluid pressure in control chamber 62 is supplied by a regulator valve generally designated 80. As the pressure is developed in chamber 62 via the regulator valve 80, the pump ring 16 will pivot about pin 14 in a clockwise direction against spring 22 thereby reducing the eccentricity between the central axis 50 of flexible rotor 36 and the central axis of the inner surface 44. Thus, the central axis of inner surface 44 will be moved from position 58 toward position 60. When the axis reaches the position 60, the minimum pump displacement has been achieved and the fluid supplied at this point is sufficient to satisfy torque converter flow requirements, transmission lubrication requirements and leakage which occurs in the system.

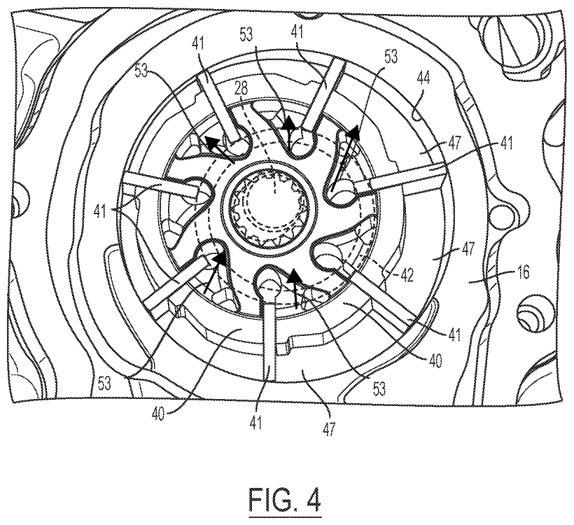

Under most operating conditions, the axis of inner surface 44 will be at position 58 during low speed conditions and at position 60 during high speed conditions. As the vanes 40 are rotated from the inlet port 48 to discharge port 46 and vice versa, a pressure transition takes place with the chambers 47. The pressure transition occurs along a line which passes through the central axis 50 of flexible rotor 36 and the axis of inner surface 44. It is also understood that as the vanes 40 and flexible rotor 36 are rotated across the inlet port 48 and the discharge port 46, the flexible rotor 36 of the present disclosure is configured to flex and absorb some of the energy from the varying input oil pressure 107 thereby reducing excessive bend/stress at the base corners 45 (FIG. 4) of the rotor 36 and to reduce excessive bend/stress in the vanes 40 relative to the flexible rotor 36. Accordingly, the risk of damage to the flexible rotor 36 has been reduced.

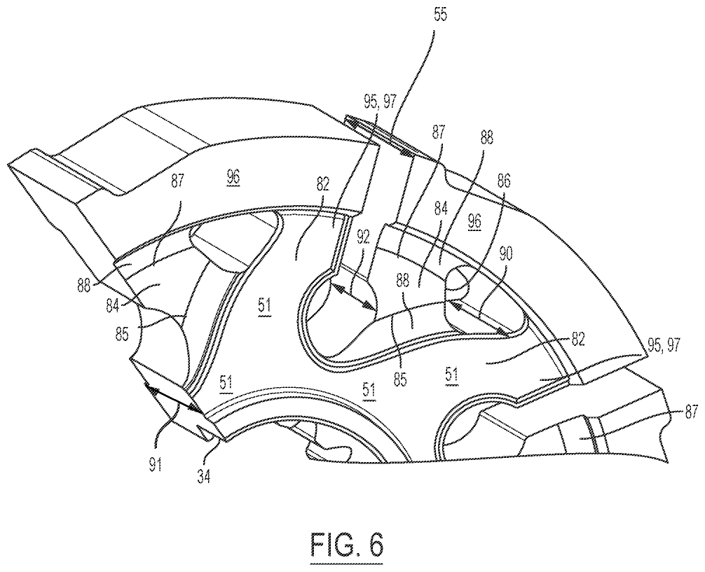

Therefore, as shown in FIG. 2-6, the present disclosure provides a robust variable displacement pump 10 according to the present disclosure wherein the pump 10 includes a flexible rotor 36 which is better able to withstand a varying input working fluid pressure 107. The variable displacement pump 10 better distributes stress from the varying input oil pressure 107 across the flexible rotor structure thereby reducing the risk of the flexible rotor 36 cracking and/or falling. The variable displacement pump 10 includes a housing 12, a vane control ring 42, a flexible rotor 36, a plurality of vanes 40, a slider ring 16, a biasing means 22, and a regulator valve 80. The housing 12 defines an inlet port 48 and a discharge port 46. The flexible rotor 36 may be driven by a drive shaft 28 and coaxially aligned with the drive shaft 28. The flexible rotor 36 defines a plurality of primary ribs 82 and a plurality of corresponding secondary ribs 84 with an aperture 86 and an optional curved surface 88 defined between each primary rib 82 and secondary rib 84. Each primary rib 82 defines a primary rib thickness 90 and each secondary rib 84 defines a secondary rib thickness 92 which is less than the primary rib thickness 90. (See FIGS. 3 and 6). Accordingly, as shown in FIG. 3, vane ring 42 is disposed on the vane ring pocket 51 (see also FIG. 6). As shown in FIG. 6, it is also understood that the thickness 91 of the vane ring pocket 51 (vane ring pocket thickness 91) may be equal to the primary rib thickness 90. However, the flow of oil 53 within the oil pump is not compromised even though the vane ring pocket surface 51 (FIG. 3) supports the vane control ring 42. Due to the decreased thickness of the secondary rib 84, it is understood that each surface of the secondary rib 84 is offset from the primary rib 82 by clearance 43 (see FIG. 3). Clearance 43 between the primary rib 82 and the secondary rib 84 enables oil 53 (or fluid) to flow past the vane ring 42 as shown in the non-limiting example shown in FIG. 4.

As shown in FIG. 2, the plurality of vanes 40 in the aforementioned variable displacement pump 10 are slidably disposed in corresponding vane slots 38 of the flexible rotor 36. Each vane 40 in the plurality of vanes 40 abuts the vane control ring 42 at a proximate end 49 of each vane 40 while the distal end 41 of each vane 40 abuts the inner surface of the slider ring 16. The slider ring 16 may be pivotally affixed to the housing 12 via a pivot 14. The slider ring 16 defines a displacement control region 62 with a first portion 13 of the housing 12. The slider ring 16 cooperates with the vane control ring 42, the flexible rotor 36, and the plurality of vanes 40 to form a plurality of pumping chambers 47 that are successively connected to the inlet and discharge ports (48 and 46 respectively). The biasing means 22 acts on the slider ring 16 and urges the slider ring 16 in a first direction 102 via a first force 103. A regulator valve 80 is also provided so as to generate a varying input working fluid pressure 107 via an input working fluid flow from the regulator valve 80 to the displacement control region 62 via the inlet port 48 which thereby generates a second force 104 on the slider ring 16 about the pivot means in a second direction 105. The second direction 105 is opposite to the first direction 102. The second force 104 may be configured to vary relative to the first force 103 so as vary the volume of each pumping chamber 47 while the flexible rotor 36 rotates via the drive shaft 28. As the varying input working fluid pressure 107 is applied to the plurality of vanes 40 and the flexible rotor 36, at least a portion of the flexible rotor 36 is configured to elastically flex.

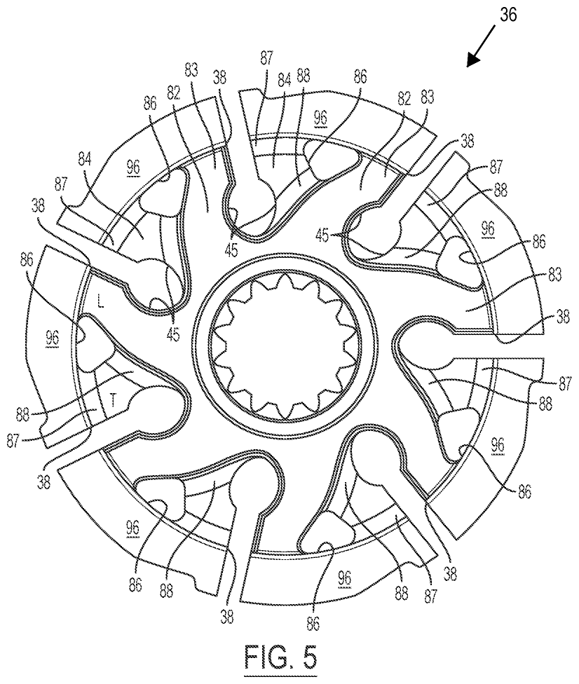

In the foregoing embodiment, at least one the secondary rib 84 in the flexible rotor 36 is configured to flex when the varying input working fluid pressure 107 is applied to the flexible rotor 36 and the plurality of vanes 40. It is also understood that the optional curved surface 88 defined adjacent to the at least one secondary rib 84 may also flex when the varying input working fluid pressure 107 is applied to the flexible rotor 36. Each optional curved surface 88 is integral to and joins the primary rib 82 to the secondary rib 84. As shown in FIGS. 4 and 5, the flexible rotor 36 of the foregoing embodiment may also include an outer rib region 96 adjacent to each aperture 86, each secondary rib 84 and each primary rib 82. Moreover, the outer rib thickness 55 (FIG. 6) may be greater than the primary rib thickness 90. The outer rib region 96 of the flexible rotor 36 may be configured to flexibly rotate counter-clockwise relative to a distal end 97 of the primary rib 82 (at apex point 95) up to about five degrees and then rotate back into the rotor's initial position shown in FIG. 3 without the rotor structure cracking given that each secondary rib 84 (with a reduced thickness 92) defines a stiffness which is relatively less than the stiffness of the primary rib 82. Accordingly, the rotor 36 is configured to elastically flex or elastically deform in at least one region having the secondary rib and the outer rib when the second force 104 (see FIG. 2) is applied to the plurality of vanes 40 and the rotor 36.

It is understood that each curved surface 88 in the flexible rotor 36 defines a rotor curved surface thickness which is less than the primary rib thickness 90 (but greater than the secondary rib thickness 92). The aforementioned optional curved surface 88(s) may be defined at the base 85 of the secondary rib 84 and/or optionally at a peripheral region 87 of the secondary rib 84—as shown in FIG. 6. Given that each secondary rib 84 and the optional curved surface 88(s) adjacent to the corresponding secondary rib 84 define thicknesses which are relatively less than the primary rib thickness 90, at least one the secondary rib 84 structure together with any corresponding curved surfaces 88 in the flexible rotor 36 is/are configured to elastically flex (or deform) when the varying input working fluid pressure 107 is applied to the flexible rotor 36 and vanes.

In another embodiment of the present disclosure, a variable displacement vane pump 10 is provided which includes a housing 12, a flexible rotor 36, a vane control ring 42, a plurality of vanes 40, a slider ring 16, a biasing means 22, and a regulator valve 80. The housing 12 defines an inlet port 48 and a discharge port 46 wherein the inlet port 48 is in fluid communication with the regulator valve 80. The flexible rotor 36 may be rotationally driven by a drive shaft 28 and coaxially aligned with the drive shaft 28. The flexible rotor 36 defines a plurality of primary ribs 82 and a plurality of corresponding secondary ribs 84 with an aperture 86 defined between each secondary rib 84 and each corresponding primary rib 82. Each primary rib 82 defines a primary rib thickness 90 and each secondary rib 84 defines a secondary rib thickness 92 which is less than the primary rib thickness 90.

In the aforementioned embodiment, the vane control ring 42 may be disposed between the flexible rotor 36 and the housing 12 wherein the vane control ring 42 is configured to move within a perimeter of the flexible rotor 36. The vane control ring 42 may include an outer surface 47 (FIG. 2) which abuts a proximate end 41 for each vane 40 in the plurality of vanes 40. The plurality of vanes 40 may also be slidably disposed in the flexible rotor 36 in a plurality of corresponding vane slots 38. Moreover, the slider ring 16 may be pivotally affixed to the housing 12 via a pivot 14 so as to define a displacement control region 62 (FIG. 2) with a first portion 13 of the housing 12. The slider ring 16 may be configured to cooperate with the vane control ring 42, the flexible rotor 36, and the plurality of vanes 40 form a plurality of pumping chambers 47 that are successively connected to the inlet and discharge ports (48 and 46 respectively) when a varying input working fluid flow/pressure 107 is supplied to the displacement control region 62. The biasing means 22 may act on the slider ring 16 so as to urge the slider ring 16 in a first direction 102 via a first (spring/biasing) force 103. However, the regulator valve 80 is configured to and generates a varying input working fluid pressure 107 via an input working fluid flow to the displacement control region 62 which thereby generates a second force 104 on the slider ring 16 about the pivot means in a second direction 105. The second direction 105 is opposite to the first direction 102. The second force 104 (via the regulator valve 80) is intended to vary relative to the first force 103 so as vary the volume of each pumping chamber 47 while the flexible rotor 36 rotates via the drive shaft 28.

In the aforementioned embodiment, at least one secondary rib 84 in the flexible rotor 36 is configured to flex when the varying input working fluid pressure 107 is applied to the flexible rotor 36. Each secondary rib 84 in the flexible rotor 36, may but not necessarily be disposed adjacent to each vane slot 38. It is also understood that the biasing means 22 may, but not necessarily, be a spring.

Therefore, in accordance with the aforementioned various embodiments of the present disclosure, the flexible rotor 36 may be driven by a drive shaft 28 and coaxially aligned the drive shaft 28. (see FIG. 2) The plurality of vanes 40 may be slidably disposed in the flexible rotor 36 within corresponding vane slots 38. The slider ring 16 may be pivotally affixed to the housing 12 via a pivot 14. The slider ring 16 may further a define a displacement control region 62 with a first portion 13 of the housing 12. The slider ring 16 may cooperates with the vane ring 42, the flexible rotor 36, and the vanes 40 to form a plurality of pumping chambers 47 which are successively connected to the inlet and discharge ports (48 and 46 respectively). 46, 48. The biasing means 22 (or a spring) may act on the slider ring 16 urging the slider ring 16 in a first direction 102 via a first force 103. Furthermore, a control unit/regulator valve 80 may be provided to generate a varying input working fluid pressure 107 via an input working fluid flow to the displacement control region 62 thereby generating a second force 104 on the slider ring 16 about the pivot means 14 in a second direction 105 opposite to the first direction 102. The second force 104 may be configured to vary relative to the first force 103 (second force 104 being greater than the first force 103 or less than the first force 103) so as vary the volume/size of each pumping chamber 47 by pivoting the slider ring 16 back and forth (between the first direction 102 and second direction 105) while the flexible rotor 36 and vanes 40 rotate via the drive shaft 28. It is understood that the vane ring 42 enables the distal end 41 of each vane 40 in the plurality of vanes 40 to abut and continuously slides along an inner surface 44 of the slider ring 16 when the flexible rotor 36 (and vanes 40) rotate within the slider ring 16. (See FIGS. 2-3).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A variable displacement pump comprising:
a housing defining an inlet port and a discharge port;
a vane control ring;
a rotor driven by a drive shaft and coaxially aligned with the drive shaft, the rotor defining a plurality of primary ribs and a plurality of secondary ribs which correspond with the plurality of primary ribs, the rotor further defining an aperture between each primary rib and each corresponding secondary rib, each primary rib having a primary rib thickness and each secondary rib having a secondary rib thickness which is less than the primary rib thickness;
a plurality of vanes slidably disposed in the rotor, each vane in the plurality of vanes abutting the vane control ring at a proximate end of each vane;
a slider ring pivotally affixed to the housing via a pivot, the slider ring defining a displacement control region with a first portion of the housing, the slider ring cooperating with the vane control ring, the rotor and the plurality of vanes form a plurality of pumping chambers that are successively connected to the inlet and discharge ports;
a biasing means acting on the slider ring and urging the slider ring in a first direction via a first force; and
a regulator valve configured to generate a varying input working fluid pressure via an input working fluid flow to the displacement control region thereby generating a second force on the slider ring about the pivot means in a second direction opposite to the first direction, the second force configured to vary relative to the first force so as vary the volume of each pumping chamber while the rotor rotates via the drive shaft;
wherein the secondary rib has a lower stiffness relative to the primary rib.

2. The variable displacement pump as defined in claim 1 further comprising a curved surface defined between each primary rib and each secondary rib, wherein at least one of the secondary ribs and the curved surface are configured to elastically flex when the varying input working fluid pressure is applied to the rotor.

3. The variable displacement pump as defined in claim 2 wherein an outer rib region of the rotor is configured to rotate counter-clockwise about an apex point proximate to a distal end of the primary rib and adjacent to the aperture.

4. The variable displacement pump as defined in claim 3 wherein a clearance is defined between each primary rib and each secondary rib proximate to the vane control ring.

5. The variable, displacement pump as defined in claim 4 wherein the curved surface is defined at the base of the secondary rib.

6. A variable displacement pump comprising:
a housing defining an inlet port and a discharge port;
a rotor driven by a drive shaft and coaxially aligned with the drive shaft; the rotor defining a plurality of primary ribs and a plurality of corresponding secondary ribs with an aperture and a curved surface defined between each secondary rib and each primary rib, each primary rib having a primary rib thickness and each secondary rib having a secondary rib thickness which is less than the primary rib thickness;
a vane control ring disposed between the rotor and the housing, the vane control ring configured to move within an outer perimeter of the rotor;
a plurality of vanes slidably disposed in the rotor, each vane in the plurality of vanes abutting the vane control ring at a proximate end of each vane;
a slider ring pivotally affixed to the housing via a pivot, the slider ring defining a displacement control region with a first portion of the housing, the slider ring cooperating with the vane control ring, the rotor and the plurality of vanes form a plurality of pumping chambers that are successively connected to the inlet and discharge ports;
a biasing means acting on the slider ring and urging the slider ring in a first direction via a first force; and
a regulator valve configured to generate a varying input working fluid pressure via an input working fluid flow to the displacement control region thereby generating a second force on the slider ring about the pivot means in a second direction opposite to the first direction, the second force configured to vary relative to the first force so as vary the volume of each pumping chamber while the rotor rotates via the drive shaft.

7. The variable displacement pump as defined in claim 6 wherein at least one secondary rib in the rotor is configured to elastically flex when the varying input working fluid pressure is applied to the rotor.

8. The variable displacement pump as defined in claim 7 wherein each secondary rib in the flexible rotor may but not necessarily be disposed adjacent to each vane slot.

9. The variable displacement pump as defined in claim 8 wherein the biasing means is a spring.

10. The variable displacement pump as defined in claim 9 wherein a vane ring pocket thickness is equal to the primary rib thickness.
